(19) United States
(12) Patent Application Publication
(10) Pub. No.: US 2020/0286140 A1
(43) Pub. Date: Sep. 10, 2020

(54) System and Method for Allowing Students to Trade Product In a Campus

(71) Applicant: ipCapital Group, Inc., Williston, VT (US)

(72) Inventors: John Cronin, Jericho, VT (US); Michael D'Andrea, Burlington, VT (US); Charles Root, JR., Underhill, VT (US); William M. Peters, JR., Williston, VT (US); William M. Peters, SR., Williston, VT (US)

(21) Appl. No.: 16/297,519

(22) Filed: Mar. 8, 2019

(51) Int. Cl. G06Q 30/06; G06Q 20/32

(52) U.S. Cl. CPC G06Q 30/0609; G06Q 30/0607; G06Q 30/0613; G06Q 20/3278; G06Q 20/3224

(57) ABSTRACT

Methods and apparatus consistent with the present disclosure may allow students or other individuals to purchase product from or to trade products with their peers when both a purchaser and a distributor are physically located within a same general location. In such instances, the purchaser and a product distributor may be located within the boundaries of a school or campus that may span only a few city blocks. Both the purchaser and the distributor may both be members of an organization associated with the general location. Methods and apparatus consistent with the present disclosure may allow a purchaser to order products that they need for delivery by another student without either student having to travel to a retail store to pick up an ordered product. Apparatus consistent with the present disclosure may receive information from a product tag as an ordered product is processed for delivery.

### CROSS REFERENCE TO RELATED APPLICATIONS

The present disclosure incorporates by reference and claims priority to provisional patent application 62/640,109, filed on Mar. 8, 2018, and entitled “System and Method for Allowing Students to Trade Product In a Campus.”

### BACKGROUND OF THE INVENTION

### Field of the Invention

The present disclosure is generally related to online retailing of products. More specifically the present disclosure is directed to methods and apparatus allows members of a group to purchase or trade products while tracking the delivery of these products to a recipient.

### Description of the Related Art

Near-Field Communication (NFC) is a form of short-range, low-power wireless communication technology for electronic devices which allows users to communicate with others by simple touching or bringing the electronic devices at dose distance. NFC technology allows electronic devices to transmit data over short distances, in certain instances, one only need to bring two devices dose to each other and the two devices will then communicate with each other. NFC devices include passive NFC chips, active NFC chips, NFC chip readers, and electronic devices that include NFC communication technology. Passive NFC chips do not have a power source electrically connected to them, instead passive NFC chips harvest electromagnetic energy emitted by an NFC electronic device, like an NFC reader device. In contrast, active NFC chips have a power source that is electrically connected to them. Since active NFC chips include a power supply, they may be communicate with other NFC devices over farther distances than passive NFC chips: simply put, radio communications associated with active NFC chips can have a greater range than passive NFC chips because active NFC chips have a power supply. NFC readers or computing devices with NFC transceivers (e.g. cellphones, computers, or laptops) can also communicate with each other. In certain instances computing devices with NFC transceivers may communicate as if they were a NFC chip. Distances associated with short distance NFC communications are usually about 4 cm (1.6 inches). NFC chips and NFC devices typically communicate with each other according to an NFC protocol. Furthermore, NFC-enabled devices are used today in contactless payment systems, where they allow payments to be made using NFC communications. NFC may also be used for social networking communications, sharing contacts, photos, videos, or files. Typically, NFC offers a low-speed connection with simple setup that may be used to bootstrap more capable wireless connections. NFC-enabled devices may be used as a form of electronic identity documents or cardkey. NFC chips are also sometimes referred to as NFC tags or radio frequency identifier (RFID) tags.

Currently, NFC has various applications in a field of identification, authentication, ticketing systems, public transport (e.g. trains & buses), contactless electronic payment, and Electronic Point of Sales (EPOS) terminals at shopping malls. NFC is used for data transfer or data beaming in applications, such as smart posters or simplifying a setup of more complex communication methods. For example, NFC communications may help configure a Wi-Fi. Connection. NFC tags may also be used to identify or track the movement of products or other items that they are attached to or embedded in. Any number of NFC/RFID tags may be associated with desired products or services, allowing NFC-enabled devices to read or scan respective NFC/RFID tags and access information stored at the respective NFC/RFID tag on demand. NFC tags are also sometimes associated with asset tracking, order adherence, rewards management, content delivery, or counterfeit detection.

Currently, NFC/RFID tags are not tailored for use by students in a way that enables them to control their spending. Students often over spend on products when they buy products at “a last minute” when a need arises. Sometimes students do not purchase healthy nutritional food when they make such last minute purchases. Many students are also interested in earning money to support school and living expenses. In instances where students have to leave their school campus to work, they may have to spend additional time traveling to and from a job, this can cause students to study less than they otherwise could if they did not have to travel to the job. The current state of the art lacks an efficient mechanism for allowing the students to purchase or trade products at a location, such as their campus. What are needed are new systems and methods that allow students to purchase products at a reasonable cost while allowing other students to earn money by providing those products to their peers. What are also needed are new ways that allow individual associated with a location to purchase or trade products.

### SUMMARY OF THE PRESENTLY CLAIMED INVENTION

The presently claimed invention relates to a method, a non-transitory computer readable storage medium, and an apparatus that may help organize the delivery of products to individuals located within a geographic area or that are associated with an organization. Methods consistent with the present disclosure may include receiving a product order from a user device located in a geographic area, selecting a registered distributor that may coordinate the delivery of the ordered product, sending the order to an electronic device associated with the selected distributor, receiving product tag information indicating that the registered distributor has accessed the ordered product, and receiving product tag information that identifies that the product has been received by a user of the user device.

When the presently claimed invention is implemented as a non-transitory computer-readable storage medium, a processor executing instructions out of a memory may perform steps consistent with the presently claimed method. Here again the method may include receiving a product order from a user device located in a geographic area, selecting a registered distributor that may coordinate the delivery of the ordered product, sending the order to an electronic device associated with the selected distributor, receiving product tag information indicating that the registered distributor has accessed the ordered product, and receiving product tag information that identifies that the product has been received by a user of the user device.

An apparatus consistent with the present disclosure may include a processor that executes instructions out of a memory to receive an order for a product from a user device that is located in a geographic area, prepare the order for the product to be sent to a selected distributor device, wherein the order is sent to the selected distributor device, identify that tag information received from the selected distributor device indicates that a registered distributor of the one or more registered distributors has accessed the ordered product, and to identify that a user of the user device has received the product based on tag information that may have been received from the user device.

### BRIEF DESCRIPTION OF THE DRAWINGS

FIG. 1 illustrates a system where students that wish to purchase or trade products, may order products for delivery by other students.

FIG. 2 illustrates components of an apparatus that may allow students to purchase or trade products.

FIG. 3 illustrates steps of a flow chart of a method consistent with the present disclosure that organize the delivery of ordered products.

FIG. 4 illustrates a set of steps of a method that may be performed when a person wishes to enroll as a product distributor.

FIG. 5 illustrates a flowchart of steps that may be performed by a computing device that organizes the ordering and delivery of products.

FIG. 6 illustrates a flowchart of steps that may be used to track the delivery of an order.

FIG. 7 illustrates a flowchart of steps that may be performed by a software module that may help coordinate the delivery of ordered products.

FIG. 8 illustrates steps of a flowchart that may be performed by an advertising software module.

FIG. 9 illustrates a flowchart that includes steps that allow students to trade products at a campus.

FIG. 10 illustrates a computing system that may be used to implement an embodiment of the present invention.

### DETAILED DESCRIPTION

The present disclosure allows students or other individuals to purchase or trade products with their peers when both a purchaser and a distributor are physically located within a same general location. In such instances the purchaser (or product “receiver”) and a product distributor may be located within the boundaries of a school or campus. Both the purchaser/receiver and the distributor will both typically be located within the same general area (e.g. within a few city blocks) where both the purchaser/receiver and the distributor may both be members of an organization associated with the general location. Methods and apparatus consistent with the present disclosure allow a purchaser (that may be referred to as a “receiver student”) could easily order products that they need for delivery by another student (that may be classified as a registered as a “distributor student”). The receiver student could benefit from knowing that they can acquire products at a reasonable cost and the distributor student could benefit by making some money for delivering an ordered product to the receiver student.

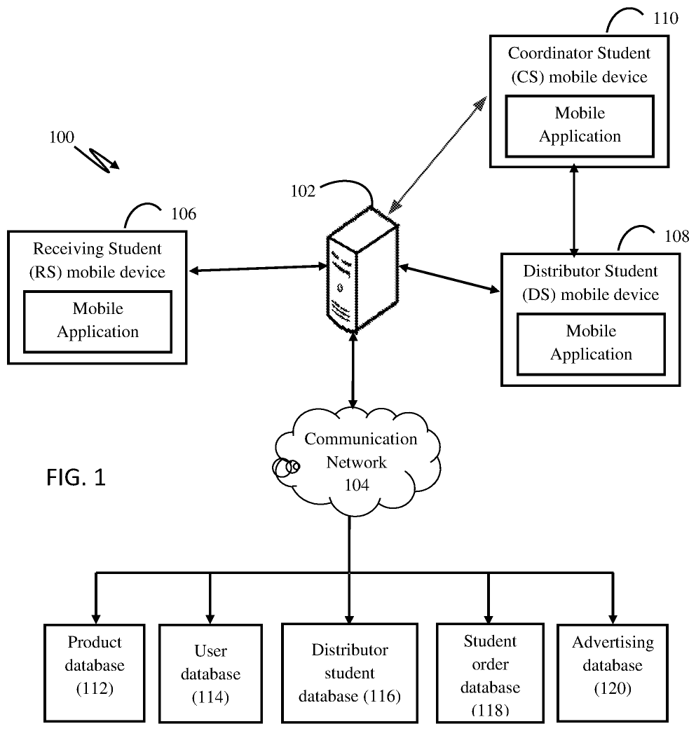

FIG. 1 illustrates a system where students that wish to purchase or trade products, may order products for delivery by other students. FIG. 1 includes networked system 100 that includes computer 102 that may allow students to purchase or trade products. Computer 102 may be communicatively connected to communication network 104, receiving student (RS) mobile device 106, and a distributor student (DS) mobile device 108. The DS mobile device 108 may further be communicatively connected with a coordinator student (CS) mobile device 110. Through the communication network 104, computer 102 may be connected with one or more databases 112, 114, 116, 118, & 120 (112-120). Computer 102 may also communicate with CS device 110. Computer 102 may communicate with RS device 106, DS device 108, and CS device via communication network 104 or via other communication pathways. These other communication pathways include wireless communication pathways such as a cellular network.

Communication network 104 may be a wired network, a wireless network, or a combination of both. Wireless networks consistent with the present disclosure may be implemented using any communication technology known in the art, including, yet not limited to technologies such as: visible light communications (VLC), optical communications, worldwide interoperability for microwave access (WiMAX), long term evolution (LTE), wireless local area networks (WLAN), infrared (IR) communication, public switched telephone network (PSTN), radio waves, cellular network, or other communication network.

RS mobile device 106 may be used by a student that wishes to place an order to receive a product. A mobile application installed on the RS mobile device 106 may be used to find products that can be ordered via communication network 104. The receiving student may select at least one or more products when they place an order. In one example, a mobile application installed on RS mobile device 106 may be referred to as a “Scholar Starter Application.” In one instance, such application programs may display a list products based on a location of the receiving student. The location of the receiving student may be retrieved from Global Positioning System (GPS), assisted GPS, Wi-Fi, or other location determining services.

The DS mobile device 108 may be used by a distributor student when that distributor student provides products to other students at a campus. Each product sold via the distributing student may be associated with one or more Near-Field Communication (NFC) tags. These NFC tags may also be physically attached to each of respective product offered for sale. In an example, DS mobile device 108 may receive an order via a mobile application installed on DS mobile device 108. DS mobile device 108 may coordinate with the CS mobile device 110 for delivering products included in a particular order. It should be noted that a mobile application may also be installed at the CS mobile device 110. The CS mobile device 110 may receive a notification corresponding to the delivery of the product related to the order. Each of the respective devices illustrated in FIG. may communication via communication network 104 or via other communication channels known in the art.

The group of databases (112-120) may include a product database 112, user database 114, distributor student database 116, student order database 118, and an advertising database 120. Different databases are used in present case; however, a single database may also be used for storing the data. Usage of the different databases may also allow segregated storage of different data and may thus reduce time to access required data.

Product database 112 may be configured to store information that identifies a plurality of different products. Each product of the plurality of products may be associated with at least one unique NFC tag or other identifier. In such an instance, product database 112 may store a current inventory location of the plurality of products. The plurality of products offered for sale may be delivered by one or more distributor students.

User database 114 may be configured to store user demographic information. user. Such user demographic information may include age, gender, or interests of particular users. The user database 114 may store information related to an order placed by a student that wishes to receive a product. The order may be related to at least one product of a plurality of products ordered by a receiving student. User database 114 may also store marketing information. This marketing information may include a number of times a particular student ordered a particular product, for example.

Distributor student database 116 of FIG. 1 may be configured to store demographic information related to distributor students. Here again, demographic information may include age, gender, or interests of the distributor students. The distributor student database 116 may also store information such as grade point average (GPA) or various programs that respective distributor students are enrolled in. These programs may be a part of University's criteria for being a distributor student.

In one instance, student order database 118 may be configured to store information related to orders placed by a receiving student. In one instance, student order database 118 may store a location of the receiving student. The advertising database 120 may be configured to store advertising programs. The advertising database 120 may further store qualification criteria for these advertising programs. In one instance, an advertising program may allow companies to provide products to receiving students when those companies are interested in receiving feedback from receiving students. Furthermore mobile applications consistent with the present disclosure may be hosted on computer 102 for allowing the students to trade products at a location or on a campus. As such, certain students may be listed as both a receiving student and a distributing student.

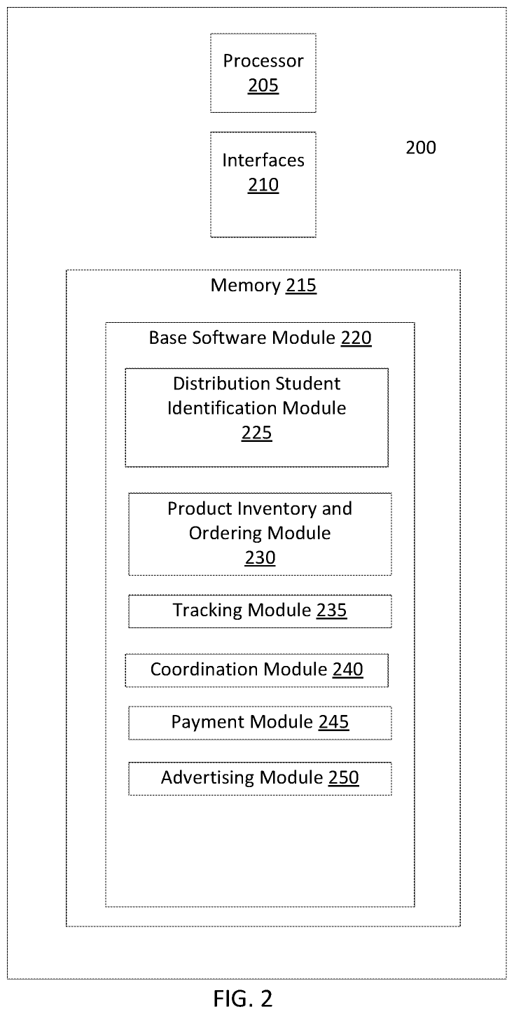

FIG. 2 illustrates components of an apparatus that may allow students to purchase or trade products. The apparatus 200 of FIG. 2 includes processor 205, interface(s) 210, and memory 215. Memory 215 includes base software module 220, distributor student identification module 225, product inventory and ordering module 230, tracking module 235, coordination module 240, payment module 245, and advertising module 250. Processor 205 may execute an algorithm stored in the memory 215 for allowing students to trade or purchase products. The processor 205 may also execute instructions out of a memory to decode and organize information received from one or more other electronic devices or server(s) when orders are processed and fulfilled. Processor 205 may be or include one or more general purpose processors (e.g., INTEL® or Advanced Micro Devices® (AMD) microprocessors) or one or more special purpose processors (e.g., digital signal processors or Xilinx® System On Chip (SOC) Field Programmable Gate Array (FPGA) processor). The processor 205 may be configured to execute one or more computer-readable program instructions, such as program instructions to carry out any of the functions consistent with the present disclosure.

The interface(s) 210 may help an operator interact with the computer 102 of FIG. 1. Interface(s) 210 may be provided by computer 102 of FIG. 1 and may be used to accept an input from the operator, to provide an output to the operator, or both. Exemplary interface(s) 210 may include, yet are not limited to a command line interface (CLI), a Graphical User Interface (GUI), or a voice interface.

The memory 215 may include one or more memory devices that may include, yet are not limited to, fixed (hard) drives, magnetic tape, floppy diskettes, optical disks, compact disc read-only memories (CD-ROMs), magneto-optical disks, semiconductor memories, read only memories (ROMs), random access memories (RAMs), programmable read-only memories (PROMs), rasable PROMs (EPROMs), electrically erasable PROMs (EEPROMs), flash memory, magnetic or optical cards, or other type of media/machine-readable medium suitable for storing electronic instructions or computer data.

Memory 215 may include modules implemented as a program. Memory 215 may store a base software module 220. Base software module 220 may include a distributor student (DS) identification module 225, product inventory and ordering module 230, tracking module 235, coordination module 240, payment module 245, and an advertising module 250. Software modules consistent with the present disclosure may be included on one or more discrete sets of software programs or application programs. In an instance where multiple discrete sets of software programs are used to implement particular software functions, the functions associated with a particular discrete program may be updated by updating only that particular discrete program.

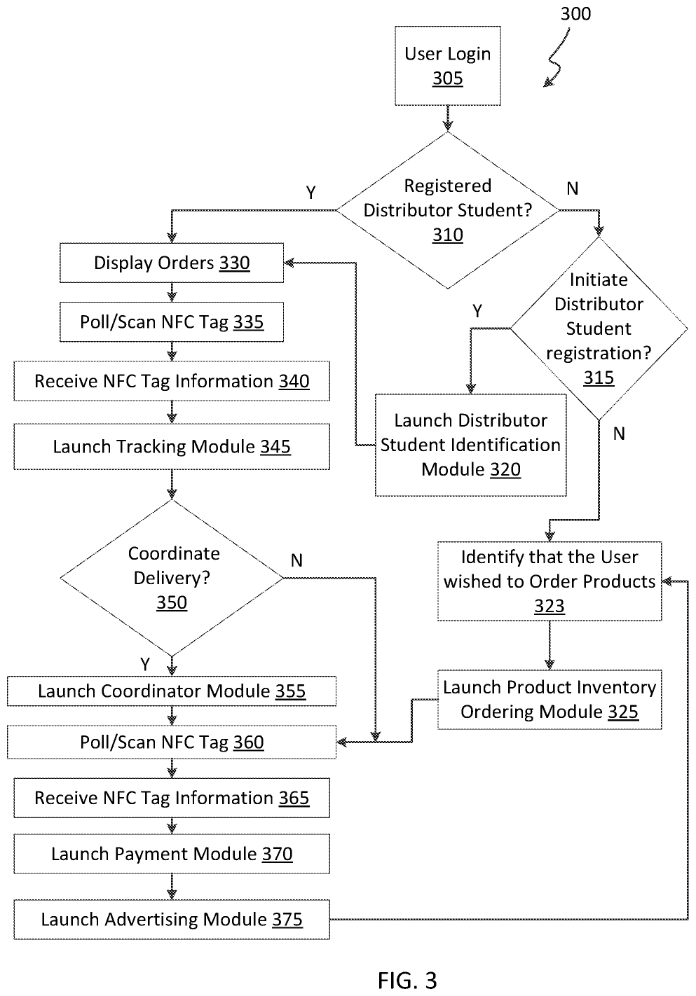

FIG. 3 illustrates steps of a flow chart of a method consistent with the present disclosure that organize the delivery of ordered products. FIG. 3 includes flowchart 300 that may be performed by a base software module consistent with the present disclosure. While FIG. 3 illustrates a particular order of steps, methods consistent with the present disclosure may be performed in a different order or include additional or fewer steps.

At step 305 of FIG. 3, user log-in data may be received by a mobile application. It should be noted that the user log-in data may belong to a distributor student (i.e. a student that may distribute or that organizes the distribution of products) or a receiving student (i.e. a student that may order products). Further, the mobile application may be installed at RS mobile device 106 or the DS mobile device 108 of FIG. 1. In one instance, the mobile application may be hosted on computer 102 (of FIG. 1) or may allow students to trade products for other products at a school campus. In certain instances, a particular student could be both a distributor and a receiving student.

Next, the base software module may identify in determination step 310 whether the user is registered as a distributor student. When the user is not registered as a distributor student, then the base software module may move to step 315 that may identify whether the user wants to register as the distributor student. Alternatively, when the user is a registered distributor student program flow may move to step 330.

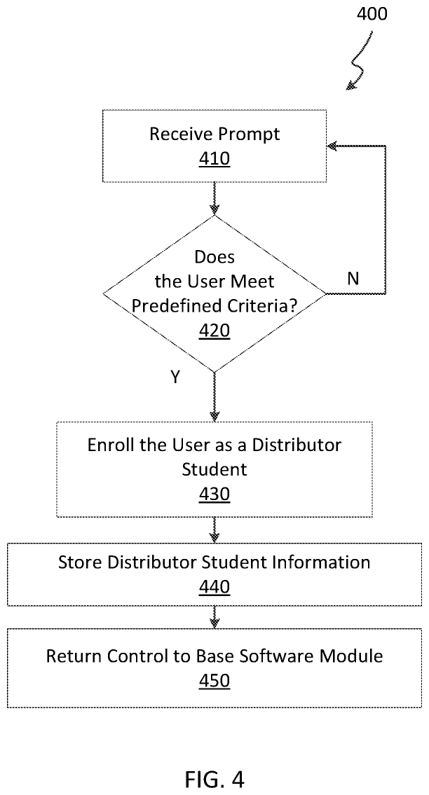

When determination step 315 identifies that the user wants to register as the distributor student, then the base software module may register the student as a distributor student in step 320 of FIG. 3. The process of registering a distributor student may include launching the DS identification module after which the steps discussed in respect to FIG. 4 may be performed. After the user has successfully registered as a distributor student program flow may move to step 330 of FIG. 3.

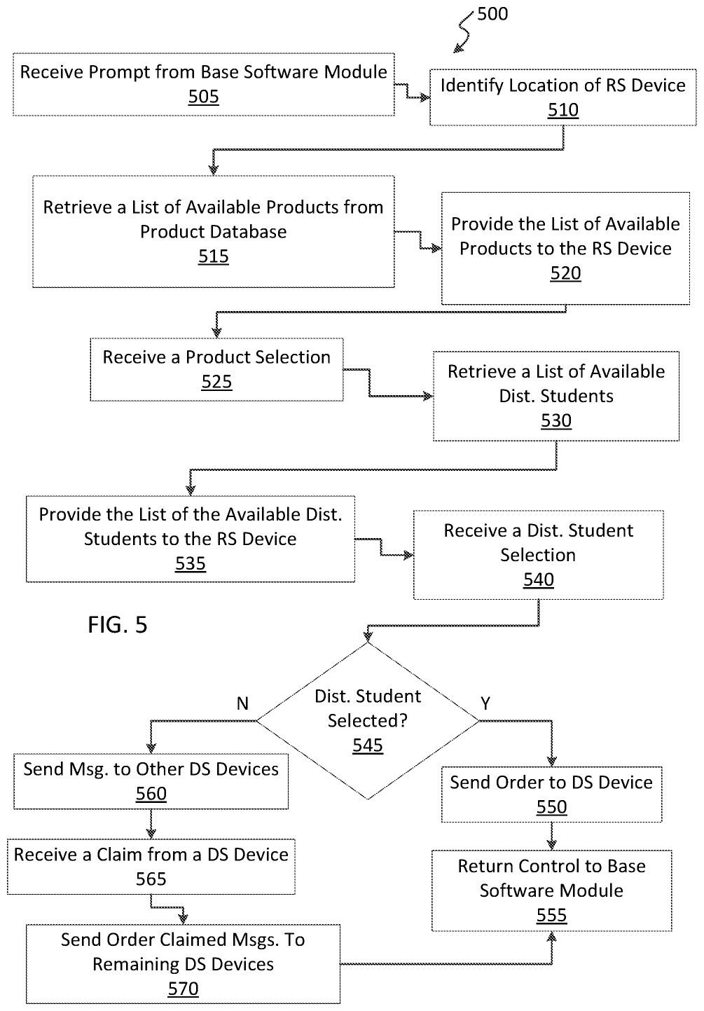

In an instance where determination step 315 identifies that the student does not wish to register as a distributor student, program flow may move to step 323 that may identify that the user wishes to order one or more products. After step 323 program flow may move to step 325 that may launch a product inventory ordering module. Such a product ordering module may provide a list of products that currently are available for purchase or sale. In certain instances, this list of available products may be provided to a user mobile device for display in a graphical user interface. The functionality of an exemplary product information ordering module is illustrated in FIG. 5 of the present disclosure.

In the instance where the user is identified as being a registered distributor student program flow may move from determination step 310 to step 330 where pending orders may be displayed in a display at a computing/mobile device of the user/distributor student. The orders displayed on the distributor student (DS) device may have been stored in the student order database 118 of FIG. 1 and this order information may have been sent to the DS device from computer 102 of FIG. 1. These orders may be related to one or more products of a plurality of products that have been ordered by different respective receiver students (RS) via different respective RS devices. In such instances, each product of the plurality of products may be attached or be associated with at least one unique near field communication (NFC) tag or identifier.

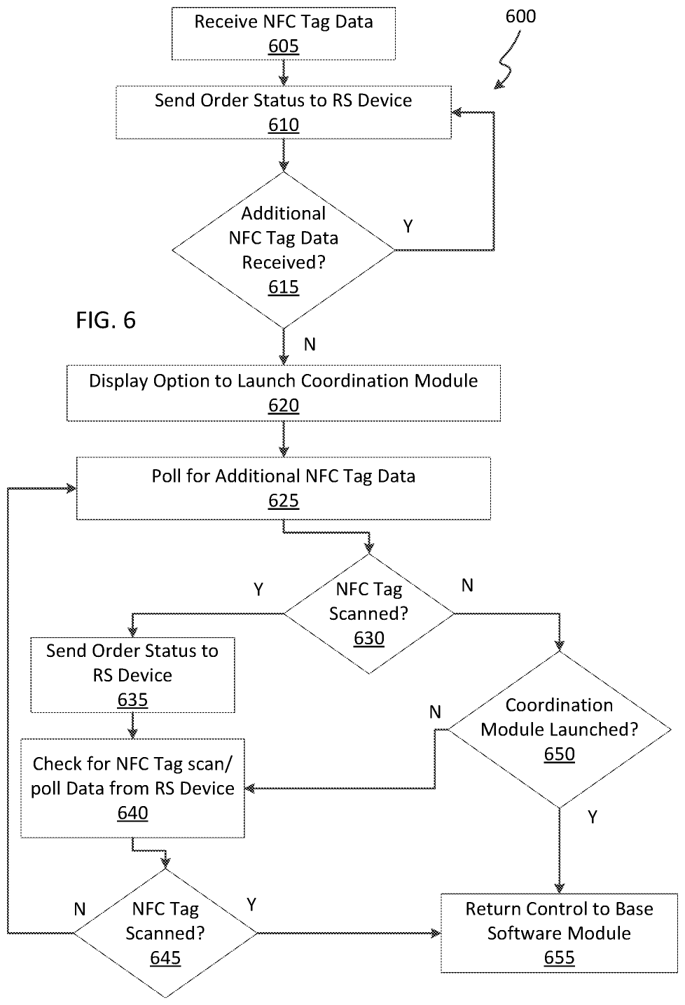

Upon receiving an order a particular distributor student may access a physical inventory of products, find an ordered product, and scan an NFC tag associated with that product. The scanning (polling) of the NFC tag in associated with the product in step 335 may cause a DS device to receive NFC tag information in step 340 of FIG. 3. Next a tracking module may be launched in step 345 of FIG. 3. Operation of an exemplary tracking module consistent with the present disclosure is shown in FIG. 6 of the present disclosure.

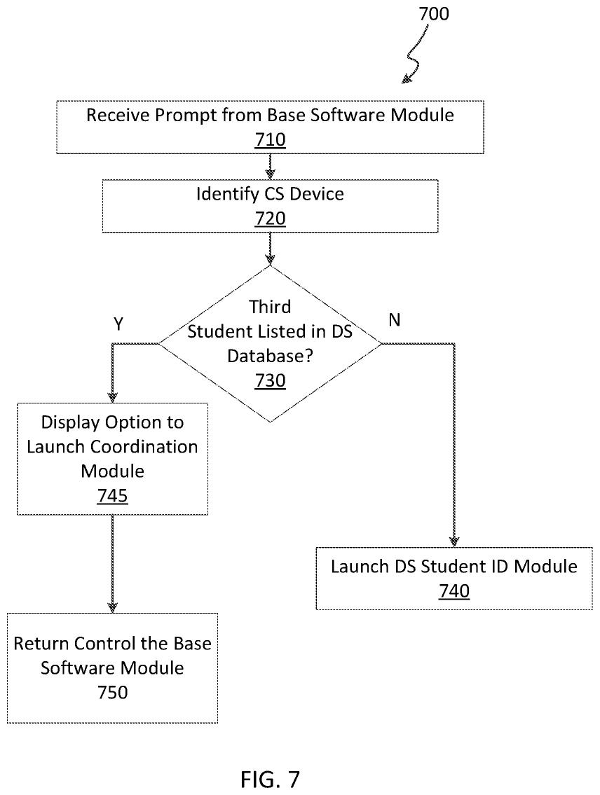

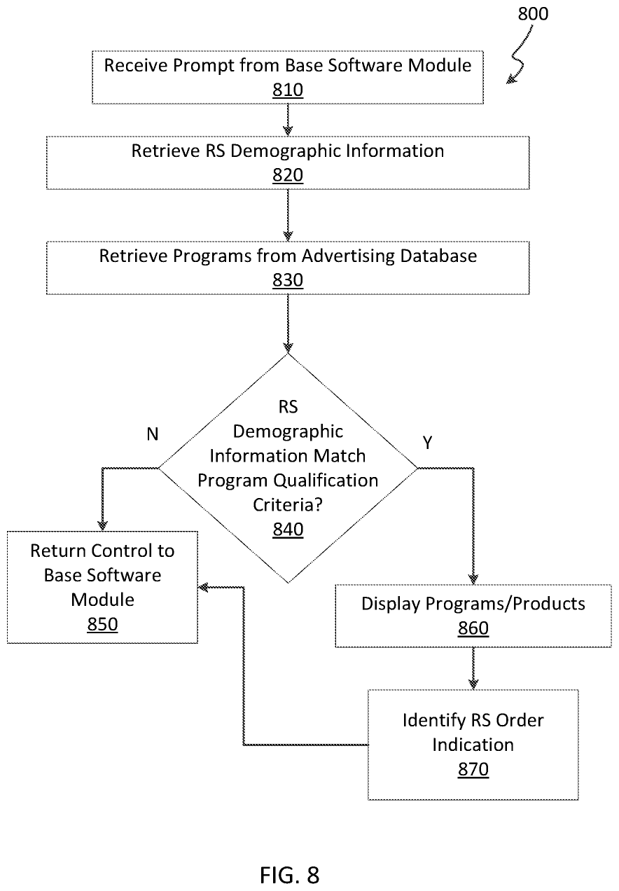

The base software module may then identify that the distributor student wants to coordinate delivery, at determination step 350 of FIG. 3. Based on the determination, the base software module may launch a coordination module at step 355 when a distributor student coordinates the delivery of a product. Steps that may be performed by a coordination module are reviewed in FIG. 7. Next, the base software module may receive NFC tag information from an NFC tag. This tag information may be read by an NFC device that transmits a signal in step 360 and that receives a response from a NFC tag in step 365 of FIG. 3. Essentially by transmitting an NFC signal in step 360, the NFC device may “poll” the NFC tag. Next the base software module may launch (initiate) a payment module to make a payment of a product associated with the NFC tag in step 370 and in step 375 an advertising module may be launched to provide advertisements to students. Functions that may be performed by an advertising module are discussed in respect to FIG. 8 of this disclosure. After step 375, program flow may flow back to step 320, where other products that have been ordered may be reviewed by a distributor student, the program flow may then move back to step 325, previously discussed.

In an example, from the perspective of a receiving student (RS) mobile device, the receiving student may log-in to a mobile application installed at their RS mobile device, to order a drink. Successively, the base software module may prompt the product inventory and ordering module to display a list of the products to the receiving student on a display of their RS device. The product inventory and ordering module may then retrieve products from the product database available at that school or location. The product inventory and ordering module may display a filterable list of the products to the receiving student. The receiving student may select “Cold Brew Inc.” from a list of the products available under a beverage category in the mobile application. The receiving student may then be allowed to select a quantity of products. After selecting the drink, the receiving student may place an order, and thereafter, notifications may be sent to the RS mobile device regarding the delivery of products that the receiving student ordered.

When the notification is sent to the RS mobile device related to the drink order ordered by the receiving student, a tracking module at the RS device may then be initiated. Such notifications may be received at the RS mobile device whenever the distributor student scans the NFC tag attached to the ordered beverage product. Based at least on a scanning a tag or identifier, a time/location of the scan may be received by the RS mobile device. At this time, the product database may be updated to link a unique number in the NFC tag to the product delivery. In one instance, the distributor student may launch a coordination module as the product is being delivered.

Further, the receiving student may scan the NFC tag attached with the product with his RS mobile device when the receiving student receives the product. Then the receiving student may then pay for the order. After receiving a payment confirmation, the base software module may launch an advertising module. The advertising module may allow companies to offer products through the mobile application at the RS mobile device. In an example, a razor company may want to provide special offers associated with a new razor to 5000 students in a college for collecting feedback related to the new razor. The razor company may prepare offer criteria to send to students of a particular demographic. For example, all male students at campuses in the North-East United States may be offered a free razor when they spend more than $10 on other products. Alternatively, the razor company may give the razor away to the first 5000 students that meet other criteria. In an example, these criteria may stipulate that receiving students that complete a survey regarding the new razor could receive the razor for free. Such criteria could also stipulate that if the receiving student does not fill out the survey within 3 days of receiving the product, then the receiving student will be charged for the new razor.

FIG. 4 illustrates a set of steps of a method that may be performed when a person wishes to enroll as a product distributor. Flow chart 400 of FIG. 4 begins with step 410 that receives a prompt. This prompt may be sent from a mobile devices associated with a prospective distributor student after that student installs and initiates an application program. Alternatively, the received prompt may be received when a web page is accessed by the mobile device associated with the prospective distributor student. Information that identifies the prospective distributor student and that identifies how that prospective distributor student is related to a particular school or campus may also be received in step 410 of FIG. 4. Next, determination step 420 may identity whether the prospective distributor student meets criteria associated with students that may be accepted as distributor students. Such criteria may require that individuals that can be accepted as a distributor student must be actively enrolled in classes at the school where they would be delivering products. These criteria may also include other requirements for accepting individuals to be a distributor student. For example, distributor students may be required to maintain a certain grade point average (GPA) or must be an individual that is known to have an upstanding moral character. Acceptance criteria may also include the overall performance of a particular user, attendance record of a user, programs that the user is enrolled in, and participation of the user in various activities of a University. It should be noted that the predefined criteria may be determined by the University.

In an instance where a particular prospective distributor student is identified as not meeting the distributor student criteria, program flow may move back to step 410, where information may be received from other prospective distributor students. When a prospective distributor student does meet the distributor student criteria, program flow may move from step 420 to step 430, where the prospective distributor student is enrolled as a distributor student. Next, in step 440 of FIG. 4, information provided during the distributor student enrollment process may be stored in a database after which program flow may move back to program code associated with a base software module in step 450.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

FIG. 5 illustrates a flowchart of steps that may be performed by a computing device that organizes the ordering and delivery of products. The steps 500 in FIG. 5 begin with step 505 that receives a prompt. This prompt may be received from a base software module after an order is received from RS device when a student wishes to purchase a product. A location of the RS device may then be identified in step 510 of FIG. 5. This location may be identified from information identified by a global positioning system (GPS) or may be identified by information entered into a user interface at the RS device. Location information consistent with the present disclosure may include GPS coordinates, an address, or a dorm room number, for example. Next, in step 515 a list of available products may be retrieved from a product database. This list of product information may include products that are known to be stored in a stock room on a campus of a school attended by a student that owns the RS device.

After step 515, step 520 may provide (or send) the list of available products to the RS device and an order may be received from the RS device in step 525 of FIG. 5. Next, a list of distributor students may be retrieved from a database in step 530, that list may be provided to the RS device in step 535, and a selection of a particular distributor student may be received from the RS device in step 540. The list of distributor students may be limited to students that have previously been registered as distributor students who attend a same school as the owner of the RS device that ordered a product. This list of distributor students may also be filtered such that only distributor students that are associated with a ‘currently working’ status are provided to the RS device.

Determination step 545 may then be used to identify whether a particular distributor student has been selected, when yes, program flow may move to step 550 where a product ordered via the RS device is sent to a device of a distributor student (a DS device) for fulfillment. After step 550, program flow moves to step 555, where steps consistent with the base software module of FIG. 3 may be performed. When determination step 545 identifies that a distributor student has not been selected, program flow may move back to step 560 of FIG. 5, where a message may be sent to other DS devices. In step 565 a claim may be received from another DS device. This claim may cause the order to be assigned to an owner of that other DS device. Next, in step 570 a message may be sent to any remaining DS devices indicating that the order has been claimed already and then control may then move to step 555, where steps consistent with the base software module may be performed

FIG. 6 illustrates a flowchart of steps that may be used to track the delivery of an order. Steps 600 of FIG. may be consistent with steps performed by tracking module 214 of FIG. 2. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

Step 605 of FIG. 6 may receive information from an NFC tag that is associated with an ordered product. This NFC tag information may have been scanned by a DS device when a distributor student accesses a product inventory when fulfilling the order. The scanning of the NFC tag may identify that a product from the inventory has been checked out for delivery. This scanning may also cause an inventory report that identifies stock at a campus storage location to be updated. For example, when an inventory identifies that the campus inventory of replacement Braun toothbrushes includes 100 brushes, that inventory may be reduced to 99 when one of those toothbrushes is scanned.

After a product is scanned in step 605, an order status message may be sent to the RS device of the person that ordered the product in step 610, and then determination step 615 of FIG. 6 may identify whether additional NFC tag data has been received. This order status information may identify a time, a location, and additional product information. Such additional NFC tag data may be related to other products ordered by the owner of the RS device. When additional NFC tag data has been received in step 615 an order status for any other product orders may be sent to the RS device at step 610. The receipt of this additional NFC data may be related to a second product ordered by a same RS device.

When additional NFC tag data has not been received in step 615, program flow may move to step 620 that may display an option to launch a coordination module. After step 620, step 625 may attempt to poll (scan) for addition NFC tag data in step 625. The launching of the configuration module may result in the selection of a coordinator that can deliver a product to a recipient. After step 625, program flow may move to determination step 630. Determination step 630 may then identify whether additional NFC tag information has been scanned or received in step 630, when yes, program flow may move to step 635 of FIG. 6. The polling or scanning of the NFC tag in step 625 may be performed by the distributor student either at a new location or may be based on a triggering of a new order made by the receiving student. In one instance, the polling in step 625 may be performed by the distributor student when they deliver a product that was ordered by a receiving student. Step 635 of FIG. 6 may then send updated order status to the receiving student device and then the RS device of that receiving student may scan the NFC tag as part of an order delivery confirmation process. After the RS device scans the NFC tag, a check to see that the RS device has scanned the NFC tag may be performed in step 640 of FIG. 6.

After step 640, determination step 645 may identify whether the receiving student RS device did scan the NFC tag of the ordered product, when yes, program flow may move back to step 655 where program control moves back to the base software module. When step 645 identifies that NFC scanned data for the ordered product has not been received, program flow may return to the previously discussed step 625 of FIG. 6.

When determination step 630 identifies that the NFC tag was not scanned in step 630, program flow may move to step 650 that determines whether the coordination module has been launched, when yes program flow may move from step 650 to step 655 where program control may be returned to the base software module. When step 650 identifies that the coordination module was not launched, program flow may move from step 650 to previously discussed step 640.

FIG. 7 illustrates a flowchart of steps that may be performed by a software module that may help coordinate the delivery of ordered products. The flowchart 700 of FIG. 7 may be performed by the coordination module illustrated as item 240 of FIG. 2. Such a coordination module may be used by or to communicate with a coordination student (CS) device when a particular coordinating student may be advised to pick up and deliver a product. Flowchart 700 begins with step 710 where a prompt may be received from a base software module. The prompt received in step 710 may be an indication received via an interface at a DS student device, when a distributing student wishes or needs to have a product delivered by a coordinating student. After the prompt is received in step 710, a CS device may be identified in step 720 of FIG. 7. The CS device may be identified by a computing device, such as computer 102 of FIG. 1. The identification of the CS device may include identifying particular coordinating students that should be available to coordinate a delivery. A particular coordinating student may alternatively be selected by a distributing student. The selection of a coordinating student may be accomplished using a schedule that identifies times when particular coordinating students are available to perform deliveries. Alternatively or additionally, the identification of a CS device may be performed by sending communications to respective CS devices that are associated with a particular campus.

Next, in step 730 of FIG. 7, a third student may be identified by checking a DS database. This DS database may store information relating to students that may be designated as a coordinating student. In an instance when a coordinate student is not identified in the DS database, then the coordination module may launch operation of a DS identification module at step 740 of FIG. 7 that may collect information relating to prospective coordinating students.

In the instance where information identifying the third student (coordinating student) are found to be present in the DS database, then the coordination module may assign the order to that coordinating student after an option has been displayed to launch operation of the coordination module in step 745 of FIG. 7. After step 745, program flow may move to step 750, where program control is returned to the base software module.

FIG. 8 illustrates steps of a flowchart that may be performed by an advertising software module. The steps of flowchart 800 of FIG. 8 may be performed by advertising module 250 of FIG. 2. In step 810 a prompt may be received from a base software module. This prompt may initiate the operation of the advertising module. Next in step 820, demographic information may be received in step 820. This demographic information may include age, gender, or interests of the receiving student. Additionally or alternatively, this demographic information may include previous purchasing habits of the receiving student or other relevant marketing data. Next, in step 830 of FIG. 8, information relating to one or more advertising programs may be received. After step 830, determination step 840 may identify whether the demographic information of the receiving student matches qualification criteria for an advertising program. For example, a demographic that identifies that the receiving student is a female student, is 21 years old, and is a student that orders a wine cooler drinks on Friday evening, determination step 840 may identify an advertising program that offers wine cooler drinks at a discount. For example, this student could be provided with a two for one offer. In an instance where a match is found in step 840, program flow could move to step 860 where an offering could be provided to a RS device for display based on the match. As such, the two for one offer could be provided to a RS device associated with the female student based on data stored in a database that identifies that she is at least 21 years old and likes wine coolers. Furthermore, such an offer could be provided to the female students RS device Friday at 5 pm in the evening based on information that identifies that she has ordered wine coolers on Friday evenings. After the offer has been provided to a RS device, information may be received from that RS device that may be used in step 870 to identify that a receiving student associated with the RS device wishes to order one or more products according to the advertising program.

After step 870, program flow may move to step 850 return program control to the base software module. Note that when determination step 840 identifies that the demographic information does not match the qualification criteria of a, program flow may move from step 840 to step 870, where program control may be returned to the base software module.

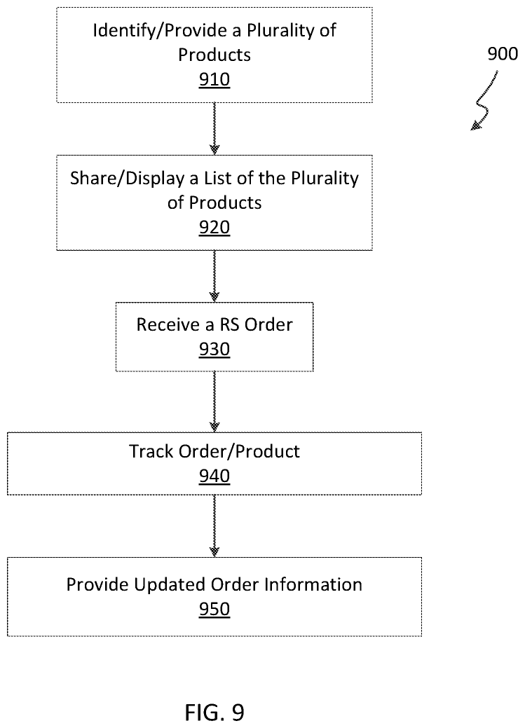

FIG. 9 illustrates a flowchart that includes steps that allow students to trade products at a campus. The flowchart 900 of FIG. 9 begins with a step 910 where a plurality of products available for trade may be identified. Information identifying each of these products may be received by computer 102 of FIG. 1 from respective receiver student devices and this information may be provided to a database that may be accessed by any of a set of persons or members via their personal computing device. Computing devices associated with receiver students participating in trading products may organized as a set of trading student (TS) devices and a list of these products may be shared with and displayed on the set of TS devices in step 920 of FIG. 9. For example, this list of products may include books for classes at a University and methods consistent with the present disclosure may allow students attending that University to exchange/trade books from one class for books from another class. Alternatively, physical products may be exchanged for money by users of respective TS devices. In certain instances, the exchange may be facilitated via a coordinating student in a manner similar to the steps reviewed in respect to FIG. 7.

Receiving students or coordinating students may be able to associate particular products using tags or labels. In such instances, students may order and receive NFC tags that can be used to facilitate, track, or validate the transfer of products from one student to another. In such instances, students may have received a set of NFC tags from a coordinating student after which those tags could be associated with a particular product via a registration process. Such a registration process may be performed by a receiver student or by a coordinating student. The registration process may include inputting information that describes a product or may include images of that product. In certain instances, a student may associate an image (e.g. a bar code, Q/R code, or image of a book—cover/spine) that may be printed and that may be uniquely associated with the product via the registration process. After a product is associated with an identifier (NFC tag or image) it may be added to the list of products that are shared in step 920 of FIG. 9.

After step 920, an order for that product may be received in step 930. Such an order may note that a receiving student is interested in trading for the product and this order may associate products that they have for trade that could be coupled to a trade agreement. Such trade agreements could include each of the students selecting a selection box that, when selected, identifies that the students agreed to terms of the trade agreement. In such an instance two different students may identify various different products to include in a trade. Alternatively or additionally, a trade may involve an exchange between more than two receiving students. In such an instance, a first student may offer a first product that a third student is interested in, the third student may have a second product that a second student is interested in, and the second student may have a third product that the first student is interested in. The three students could communicate and coordinate the delivery of each of these products to each of the three students involved in the trade. Here again, this trade may be facilitated by a coordinating student whose actions could be tracked. This tracking may include receiving tag information when the coordinating student delivers the first product to the third student, delivers the second product to the second student, and delivers the third product to the first student in a series of exchanges.

Once an agreement on a trade has been established (i.e. an order has been received) the delivery of a product may be tracked. When only two students are involved, those two students could meet and trade the agreed items or a coordinating student may pick up a first product from a first student and deliver it to a second student. The pickup and delivery of the first product may be tracked via scans at respective TS devices. For example, a first TS device may scan an identifier associated with the first product and a CS device may scan that identifier. These two scans may be used to track the custody of the product as being transferred from the first student to the coordinating student. A similar process could be performed when the second student receives and first product and custody of the first product could then be passed from the coordinating student to the second student after respective scans of the identifier. The second student could then transfer a second product to the coordinating student and the coordinating student could then deliver the second product to the first student. Each time a respective product changes hands—one or more scans may be used to track the chain of custody of each respective product as that custody changes over time. Each of the receiving students may be able to access information regarding the chain of custody and these students may be able to receive tracking data that identifies a current location of a coordinating student for a period of time that that the coordinating student retains custody of a product involved in a trade. Such custody and/or location tracking operations may be performed in step 940 of FIG. 9. Each time one or more products exchanges hands, information associated with that order may be updated in step 950.

In instances when the location of a coordinator is tracked, the tracking of the coordinating student may be ended when a trade is complete. Computer 102 of FIG. 1 may track the chain of custody of a product. In such an instance computer 102 may receive location information (GPS/other) from a CS device as a coordinator delivers a product. This location information may be shared with respective parties included in a transaction, purchase, or trade. After a particular transaction, purchase, or trade is complete, computer 102 may stop collecting or may stop sharing coordinating student location data with user devices that are not associated with a pending transaction involving that coordinating student. Because of this, particular RS devices may be able to track the location of an DS device, a TS device, or a CS device based on a set of rules.

Each block of FIG. 9 may represent a module, segment, or portion of code, which comprises one or more executable instructions for implementing the specified logical function(s). It should also be noted that in some alternative implementations, the functions noted in the blocks may occur out of the order noted in the drawings. For example, two blocks shown in succession in FIG. 9 may in fact be executed substantially concurrently or the blocks may sometimes be executed in the reverse order, depending upon the functionality involved. Any process descriptions or blocks in flowcharts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

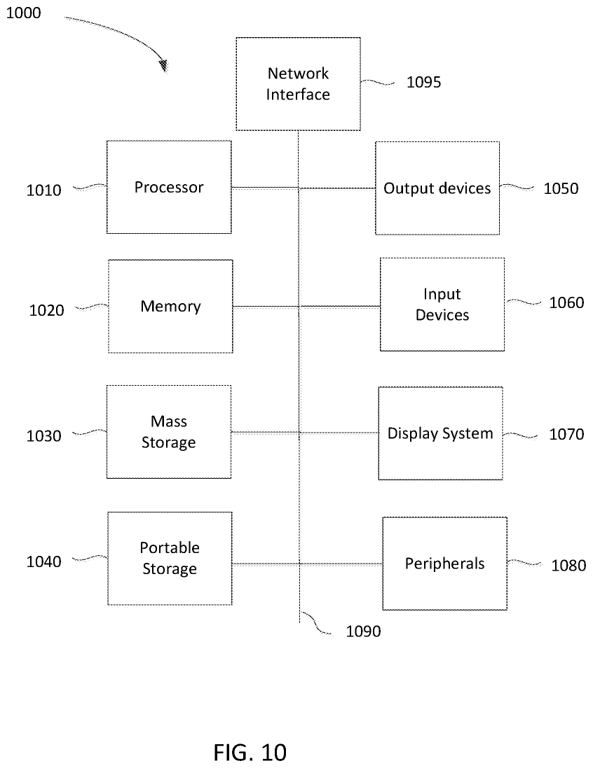

FIG. 10 illustrates a computing system that may be used to implement an embodiment of the present invention. The computing system 1000 of FIG. 10 includes one or more processors 1010 and main memory 1020. Main memory 1020 stores, in part, instructions and data for execution by processor 1010. Main memory 1020 can store the executable code when in operation. The system 1000 of FIG. 10 further includes a mass storage device 1030, portable storage medium drive(s) 1040, output devices 1050, user input devices 1060, a graphics display 1070, peripheral devices 1080, and network interface 1095.

The components shown in FIG. 10 are depicted as being connected via a single bus 1090. However, the components may be connected through one or more data transport means. For example, processor unit 1010 and main memory 1020 may be connected via a local microprocessor bus, and the mass storage device 1030, peripheral device(s) 1080, portable storage device 1040, and display system 1070 may be connected via one or more input/output (I/O) buses.

Mass storage device 1030, which may be implemented with a magnetic disk drive or an optical disk drive, is a non-volatile storage device for storing data and instructions for use by processor unit 1010. Mass storage device 1030 can store the system software for implementing embodiments of the present invention for purposes of loading that software into main memory 1020.

Portable storage device 1040 operates in conjunction with a portable non-volatile storage medium, such as a FLASH memory, compact disk or Digital video disc, to input and output data and code to and from the computer system 1000 of FIG. 10. The system software for implementing embodiments of the present invention may be stored on such a portable medium and input to the computer system 1000 via the portable storage device 1040.

Input devices 1060 provide a portion of a user interface. Input devices 1060 may include an alpha-numeric keypad, such as a keyboard, for inputting alpha-numeric and other information, or a pointing device, such as a mouse, a trackball, stylus, or cursor direction keys. Additionally, the system 1000 as shown in FIG. 10 includes output devices 1050. Examples of suitable output devices include speakers, printers, network interfaces, and monitors.

Display system 1070 may include a liquid crystal display (LCD), a plasma display, an organic light-emitting diode (OLED) display, an electronic ink display, a projector-based display, a holographic display, or another suitable display device. Display system 1070 receives textual and graphical information, and processes the information for output to the display device. The display system 1070 may include multiple-touch touchscreen input capabilities, such as capacitive touch detection, resistive touch detection, surface acoustic wave touch detection, or infrared touch detection. Such touchscreen input capabilities may or may not allow for variable pressure or force detection.

Peripherals 1080 may include any type of computer support device to add additional functionality to the computer system. For example, peripheral device(s) 1080 may include a modem or a router.

Network interface 1095 may include any form of computer interface of a computer, whether that be a wired network or a wireless interface. As such, network interface 1095 may be an Ethernet network interface, a BlueTooth™ wireless interface, an 802.11 interface, or a cellular phone interface.

The components contained in the computer system 1000 of FIG. 10 are those typically found in computer systems that may be suitable for use with embodiments of the present invention and are intended to represent a broad category of such computer components that are well known in the art. Thus, the computer system 1000 of FIG. 10 can be a personal computer, a hand held computing device, a telephone (“smart” or otherwise), a mobile computing device, a workstation, a server (on a server rack or otherwise), a minicomputer, a mainframe computer, a tablet computing device, a wearable device (such as a watch, a ring, a pair of glasses, or another type of jewelry/clothing/accessory), a video game console (portable or otherwise), an e-book reader, a media player device (portable or otherwise), a vehicle-based computer, some combination thereof, or any other computing device. The computer can also include different bus configurations, networked platforms, multi-processor platforms, etc. The computer system 700 may in some cases be a virtual computer system executed by another computer system. Various operating systems can be used including Unix, Linux, Windows, Macintosh OS, Palm OS, Android, iOS, and other suitable operating systems.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, FLASH memory, a flexible disk, a hard disk, magnetic tape, any other magnetic medium, a CD-ROM disk, digital video disk (DVD), any other optical medium, RAM, PROM, EPROM, a FLASH EPROM, and any other memory chip or cartridge.

Moreover, although the present disclosure and its advantages have been described in detail, it should be understood that various changes, substitutions and alterations can be made herein without departing from the disclosure as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

While various flow diagrams provided and described above may show a particular order of operations performed by certain embodiments of the invention, it should be understood that such order is exemplary (e.g., alternative embodiments can perform the operations in a different order, combine certain operations, overlap certain operations, etc.).

What is claimed is:

1. A method for ordering products, the method comprising:
receiving an order for a product from a user device that is located in a geographic area, wherein the user device is associated with a user;
identifying one or more distributor devices that are associated with one or more registered distributors assigned to the geographic area;
sending the order to a selected distributor device of the one or more distributor devices the order for the product;
receiving product tag information from the selected distributor device, the received product tag information indicating that a registered distributor of the one or more registered distributors has accessed the ordered product; and
receiving the product tag information from the user device that identifies that the user associated with the user device has received the product according to the order.

2. The method of claim 1, further comprising receiving location information from the user device that identifies a location in the geographic area where the user device is located.

3. The method of claim 1, further comprising:
updating a chain of custody to identify a first person that currently possesses the product after the product tag information is received from the selected distributor device; and
updating the chain of custody to identify that the user of the user device has received the product according to the order.

4. The method of claim 1, further comprising:
receiving location information that identifies the location of the selected distributor device;
sending the location of the selected distributor device to the user device when the registered distributor currently possess the product; and
preventing the transmission of the location of the selected distributor device to the user device after the user has received the product.

5. The method of claim 1, further comprising receiving the product tag information from computing device associated with a product delivery coordinator indicating that the product delivery coordinator has received the product for delivery to the user of the user device.

6. The method of claim 3, further comprising updating the chain of custody to indicate that a second person currently possesses the product based on receiving product tag information from an additional computing device.

7. The method of claim 1, further comprising:
receiving an offer to trade a second product for the product; and
receiving an indication that the offer for the trade of the product for the second product has been accepted.

8. The method of claim 7, further comprising:
updating a chain of custody to identify a first person that currently possesses the product after the product tag information is received from the selected distributor device, wherein the first person coordinates the delivery of the product to user of the user device based on the acceptance of the trade offer;
updating the chain of custody to identify that the user of the user device has received the product; and
updating the chain of custody to identify that the first person currently possesses the second product, wherein the first person coordinates the delivery of the second product to a second person according to the trade offer.

9. The method of claim 1, wherein the received tag information includes information from a near field communication (NFC) tag.

10. The method of claim 1, wherein the user of the user device and the registered distributor are both students associated with a school.

11. A non-transitory computer-readable storage medium having embodied thereon a program executable by a processor for implementing a program for ordering products, the method comprising:
receiving an order for a product from a user device that is located in a geographic area, wherein the user device is associated with a user;
identifying one or more distributor devices that are associated with one or more registered distributors assigned to the geographic area;
sending the order to a selected distributor device of the one or more distributor devices the order for the product;
receiving product tag information from the selected distributor device, the received product tag information indicating that a registered distributor of the one or more registered distributors has accessed the ordered product; and
receiving the product tag information from the user device that identifies that the user associated with the user device has received the product according to the order.

12. The non-transitory computer-readable storage medium of claim 11, the program further executable to receive location information from the user device that identifies a location in the geographic area where the user device is located.

13. The non-transitory computer-readable storage medium of claim 11, the program further executable to:
update a chain of custody to identify a first person that currently possesses the product after the product tag information is received from the selected distributor device; and
update the chain of custody to identify that the user of the user device has received the product according to the order.

14. The non-transitory computer-readable storage medium of claim 11, the program further executable to:
receive location information that identifies the location of the selected distributor device;
send the location of the selected distributor device to the user device when the registered distributor currently possess the product; and
prevent the transmission of the location of the selected distributor device to the user device after the user has received the product.

15. The non-transitory computer-readable storage medium of claim 11, the program further executable receive the product tag information from computing device associated with a product delivery coordinator indicating that the product delivery coordinator has received the product for delivery to the user of the user device.

16. The non-transitory computer-readable storage medium of claim 13, the program further executable to update the chain of custody to indicate that a second person currently possesses the product based on receiving product tag information from an additional computing device.

17. The non-transitory computer-readable storage medium of claim 11 the program further executable to:
receiving an offer to trade a second product for the product; and
receiving an indication that the offer for the trade of the product for the second product has been accepted.

18. The non-transitory computer-readable storage medium of claim 17, the program further executable to:
updating a chain of custody to identify a first person that currently possesses the product after the product tag information is received from the selected distributor device, wherein the first person coordinates the delivery of the product to user of the user device based on the acceptance of the trade offer;
updating the chain of custody to identify that the user of the user device has received the product; and
updating the chain of custody to identify that the first person currently possesses the second product, wherein the first person coordinates the delivery of the second product to a second person according to the trade offer.

19. The non-transitory computer-readable storage medium of claim 11, wherein the received tag information includes information from a near field communication (NFC) tag.

20. An apparatus for ordering products, the apparatus comprising:
a memory; and
a processor that executes instructions out of the memory to:
receive an order for a product from a user device that is located in a geographic area, wherein the user device is associated with a user, identify one or more distributor devices that are associated with one or more registered distributors assigned to the geographic area,
prepare the order for the product to be sent to a selected distributor device of the one or more distributor devices, wherein the order is sent to the selected distributor device;
identify that tag information received from the selected distributor device indicates that a registered distributor of the one or more registered distributors has accessed the ordered product; and
identify that the user associated with the user device has received the product according to the order based on receiving the product tag information from the user device.
